(19) United States
(12) Patent Application Publication
(10) Pub. No.: US 2007/0006008 A1
(43) Pub. Date: Jan. 4, 2007

(54) Replaceable layout manager for use in a device idle mode

(75) Inventor: Charles McKenna, Helsinki (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/172,745

(22) Filed: Jun. 30, 2005

(51) Int. Cl. G06F 1/26

(52) U.S. Cl. 713/323

(57) ABSTRACT

An improved system and method for displaying information on an electronic device when the electronic device is in an idle mode. The present invention includes an idle display program for exhibiting information on a display when the module is in idle mode, at least one plug-in program, and a layout manager program. The layout manager program is separate from the least one plug-in program and can be replaced, as necessary, with other layout manager programs located either within the electronic device or external to the electronic device.

### FIELD OF THE INVENTION

The present invention relates generally to mobile telephones. More particularly, the present invention relates to the use of “idle” screens on mobile telephones.

### BACKGROUND OF THE INVENTION

Many currently-manufactured mobile phones, like other electronic devices, have an “idle mode.” In an idle mode, the device is not being actively used by a user. In many instances, the device will enter the idle mode after a predetermined time interval of nonuse. When in an idle mode, certain functions in the device may be deactivated and remain deactivated until the device is actuated by the user in some manner.

In addition to other functions, in many instances certain graphics will appear on a device display when the device has entered an idle mode. As a base level, the display may, by default, include a manufacturer or supplier's logo when the device is in an idle mode. Additionally, individual software or hardware manufacturers or distributors may include more advanced graphics, changing images, or other features on the display when the device is idle.

One issue involved in the use of idle screens on electronic devices, such as mobile telephones, involves the different layout requirements and brand layouts implemented by different entities. The changing of layout managers has traditionally been very complex as the layout manager typically is combined with the idle screen program in the system memory. Because these programs are combined, they must be swapped out of the system together in order for a new layout manager to be used. This adds a great deal of complexity to the system, ultimately adding to the system cost.

### SUMMARY OF THE INVENTION

The present invention involves the creation and use of reusable idle screen software in an electronic device such as a portable telephone. By having reusable idle screen software, the layout manager for the idle screen can be built as a separate, replaceable software component. Under this system, no customized software variant is necessary.

The present invention provides the end user, as well as suppliers and manufacturers, with significant advantages over the prior art. With the present invention, customers and operators are capable of customizing the look and feel of an idle display by simply replacing the layout manager, without having to replace plug-in software or the idle application itself. This reduces the level of complexity involved in making modifications from the end user's point of view, as well as requiring less in the way of software upgrades when changes are made. The present invention also allows users to install layout managers created by third parties in order to customize the look and feel of the idle screen.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a mobile telephone that can be used in the implementation of the present invention;

FIG. 2 is a schematic representation of the telephone circuitry of the mobile telephone of FIG. 1; and

FIG. 3 is a schematic representation showing the arrangement among at least one layout manager, at least one plug-in component, and a manager library, according to one embodiment of the present invention.

### DETAILED DESCRIPTION OF THE PREFERRED EMBODIMENTS

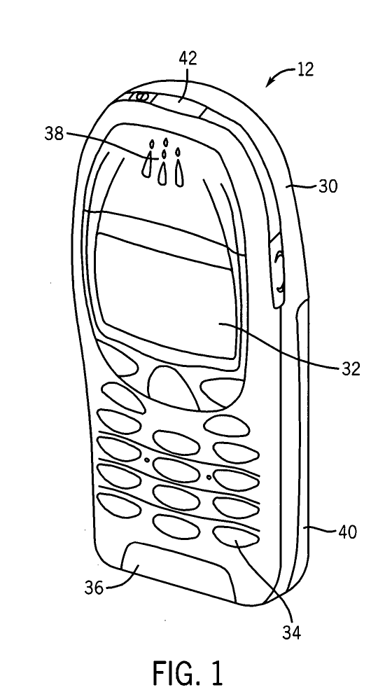

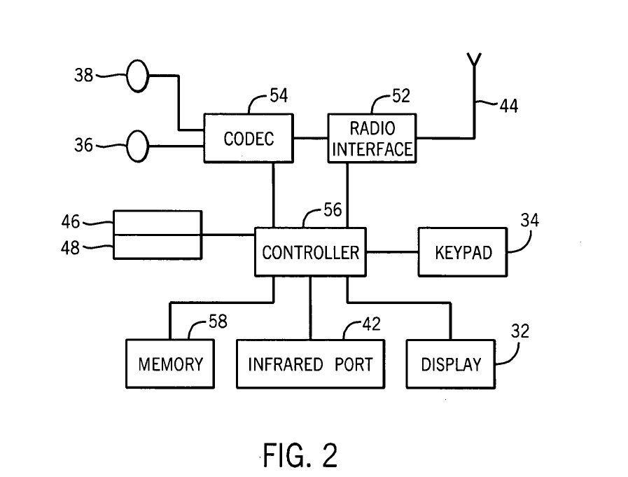

FIGS. 1 and 2 show one representative mobile telephone 12 upon which the present invention may be implemented. However, it is important to note that the present invention is not limited to any type of electronic device and could be incorporated into devices such as personal digital assistants, personal computers, and other devices. It should be understood that the present invention could be incorporated on a wide variety of mobile telephones 12. The mobile telephone 12 of FIGS. 1 and 2 includes a housing 30, a display 32 in the form of a liquid crystal display, a keypad 34, a microphone 36, an ear-piece 38, a battery 40, an infrared port 42, an antenna 44, a smart card 46 in the form of a universal integrated circuit card (UICC) according to one embodiment of the invention, a card reader 48, radio interface circuitry 52, codec circuitry 54, a controller 56 and a memory 58. It should be noted that the controller 56 can be the same unit or a different unit than the camera processor 16. Individual circuits and elements are all of a type well known in the art, for example in the Nokia range of mobile telephones.

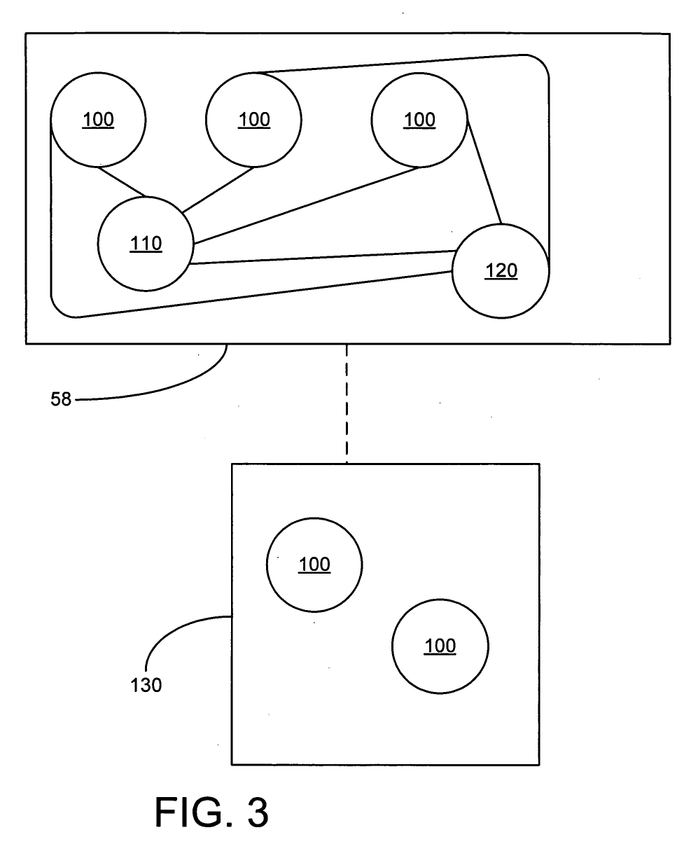

FIG. 3 shows a schematic representation of one embodiment of the present invention. In the present invention, the display 32 is operatively connected to the memory 58, which includes at least one layout manager 100 and at least one plug-in program 110. By “operatively connected,” it should be understood that it is only necessary that the layout manager 100 and the least one plug-in program 110 be manipulable such that the end result can be exhibited on the display 32. In the embodiment represented in FIG. 3, the layout manager 100 and the least one plug-in program 110 are located within the memory 58. However, it should be understood that the memory 58 can be either a single unit or multiple, separate memory units, such as separate random access memory (RAM) and read only memory (ROM). The memory 58 also includes an idle screen program 120. The idle screen program 120 is responsible for transmitting the content to be exhibited to the display 32 when the device enters an idle mode, while the least one plug-in program 110 is responsible for the actual content and can vary by software or hardware manufacturer or supplier.

In the present invention, the layout manager 100 is a separate software component from the idle screen program 120. The layout manager 100 is responsible for defining the layout (i.e., the size and position) of the plug-ins from the least one plug-in program 110. The layout manager 100 can also instruct some plug-ins not to appear at all under certain circumstances. The layout manager 100 also handles navigation between plug-ins appearing on the display 32.

The layout manager is constructed as its own dynamic link library file (DLL file). A DLL file is an executable file that cannot run on its own. Instead, a DLL file can only run from inside an executable file. To run in this manner, an executable file needs to declare the DLL function, and when needed, the DLL file is instructed to run within the required parameters. The DLL file allows the executable program to communicate with a specific device, such as a printer, or may contain source code to perform particular functions. The various plug-in programs 110 belong to their own DLL files.

The advantage of DLL files is that, because DLL files do not get loaded into random access memory (RAM) together with the main program, space is saved in the RAM. When and if a DLL file is called for action, then it is loaded.

In the context of the present invention, the DLL file for the layout manager 100 is called upon when the electronic device is to enter an idle mode. The layout manager 100 works in conjunction with the least one plug-in program 110 and the idle screen program 120 to display the idle content on the display 32.

In the present invention, different entities, such as suppliers, manufacturers, and customers, have the ability to customize their idle screen look and feel by replacing the layout manager 100 that is used. Because the layout manager 100 is a separate component from the least one plug-in program 110 and the idle screen program 120, the layout manager 100 can be replaced without replacing the other two programs, making them reusable. The plug-in program 110 (or a plurality of such programs) and the idle screen program 120 can continue to use the same interface to each layout manager 100. By replacing the layout manager 100 without replacing the other components, different customers and operators have the ability to customize their idle screen look and feel. As the layout manager is contained in a DLL file, the idle screen program can unload it from the memory at run time and load another layout manager, enabling the user to change the look and feel of the idle screen without needing to restart the idle screen program (which would normally involve a reboot for a device running embedded software) or without having to reflash the software into the read only memory of the device. Similarly, the user's mobile carrier can remotely update its branding “look and feel” of the device by replacing the active layout manager 100 of the idle screen program 120 “over the air” (OTA) using one of many OTA push technologies.

FIG. 3 shows two potential embodiments by which the layout manager 100 can be replaced. In one embodiment of the invention, the memory 58 may include a plurality of layout managers 100 on the device, and an entity wishing or needing to change layout managers 100 can do so internally. Alternatively, an entity wishing or needing to change layout managers 100 can access a remote library 130 located away from the device to retrieve a new layout manager. A combination of these two approaches can also be implemented.

The idle screen program can also change the layout manager 100 itself upon receipt of some hardware or software-generated event. For example, the layout manager 100 could be changed upon the device or screen rotating through ninety degrees. This may desirable because, if the display 32 is viewed in a different orientation, then it may require the plug-ins to be exhibited on the display 32 in a different format for clarity. In another example, the layout manager 100 could be changed to a mode where the input method and/or viewing range changes. This may be desirable in a situation such as a “hands free” mode for an automobile, where it would be desirable for the layout to include fewer plug-in programs so that the remaining programs can be exhibited in a larger form, allowing them to be more easily viewed from a greater distance.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. An electronic device, comprising:
a memory unit;
a processor for processing information from the memory unit; and
a display exhibiting information when the electronic device enters an idle mode,
wherein the memory unit includes:
an idle display program,
at least one plug-in program, and
at least one layout manager program separate from the least one plug-in program for defining the layout of material generated by the least one plug-in program.

2. The electronic device of claim 1, wherein the at least one layout manager program comprises a plurality of layout manager programs stored within the memory unit, and wherein the user is capable of selecting from one of the plurality of layout manager programs for use.

3. The electronic device of claim 1, further comprising a data communication link for accessing a remote database, the remote database including at least one additional layout manager for selective replacement of the at least one layout manager program located within the memory unit.

4. The electronic device of claim 3, wherein the remote database is accessible through the Internet.

5. The electronic device of claim 1, wherein the at least one layout manager program comprises a dynamic link library file.

6. A module capable of displaying information when in an idle mode, comprising:
a processor for processing information from the memory unit; and
a memory unit including:
an idle display program for exhibiting information on a display when the module is in idle mode,
at least one plug-in program, and
at least one layout manager program separate from the least one plug-in program for defining the layout of material generated by the least one plug-in program.

7. The module of claim 7, wherein the at least one layout manager program comprises a plurality of layout manager programs stored within the memory unit, and wherein the user is capable of selecting from one of the plurality of layout manager programs for use.

8. The module of claim 7, further comprising a data communication link for accessing a remote database, the remote database including at least one additional layout manager for selective replacement of the at least one layout manager program located within the memory unit.

9. The module of claim 8, wherein the remote database is accessible through the Internet.

10. The module of claim 7, wherein the at least one layout manager program comprises a dynamic link library file.

11. A computer program product for exhibiting information on a display when an associated device is in an idle mode, comprising:
an idle display program for exhibiting information on the display;
at least one plug-in program; and
at least one layout manager program separate from the least one plug-in program for defining the layout of material generated by the least one plug-in program.

12. The computer program product of claim 11, wherein the at least one layout manager program comprises a plurality of layout manager programs stored within the memory unit, and further comprising computer code for enabling a user to select from one of the plurality of layout manager programs for use.

13. The computer program product of claim 11, further comprising computer code for accessing a remote database, the remote database including at least one additional layout manager for selective replacement of the at least one layout manager program located within the memory unit.

14. The computer program product of claim 13, wherein the remote database is accessible through the Internet.

15. The computer program product of claim 11, wherein the at least one layout manager program comprises a dynamic link library file.

16. A method for altering a computer program product for exhibiting information on a display when an associated device is in an idle mode, comprising:
providing an idle display program for exhibiting information on the display;
providing at least one plug-in program;
providing a first layout manager program separate from the least one plug-in program for defining the layout of material generated by the least one plug-in program; and
replacing the first layout manager program with a second layout manager program.

17. The method of claim 16, wherein the first layout manager program and the second layout manager program are located within a memory unit of an electronic device.

18. The method of claim 16, further comprising the step of, before replacing the first layout manager program with the second layout manager program, retrieving the second layout manager program from a remote database.

19. The method of claim 18, wherein the remote database is accessible through the Internet.

20. The method of claim 16, wherein the first layout manager program and the second layout manager program are dynamic link library files.
